(19) United States
(12) Patent Application Publication
(10) Pub. No.: US 2009/0237338 A1
(43) Pub. Date: Sep. 24, 2009

(54) LIQUID CRYSTAL DISPLAY DEVICE AND DRIVING METHOD THEREOF, OVER-DRIVE CORRECTION DEVICE AND DATA PRODUCTION METHOD THEREOF AND ELECTRONIC DEVICE

(75) Inventor: Naoki Sumi, Hyogo (JP)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TPO DISPLAYS CORP., Miao-Li County (TW)

(21) Appl. No.: 12/406,157

(22) Filed: Mar. 18, 2009

(30) Foreign Application Priority Data
Mar. 19, 2008 (JP) 2008071534

(51) Int. Cl. G09G 3/36

(52) U.S. Cl. 345/89; 345/87

(57) ABSTRACT

A driving method for a liquid crystal display device and an over-drive correction device, which can perform proper overdrive control in various operating environments. The over-drive correction device includes a dummy liquid crystal unit embedded in the liquid crystal display device, a liquid crystal capacitive sensor to detect a capacitance (dielectric constant) of the dummy liquid crystal unit, a calculation circuit for lookup tables, an overdrive lookup table, a prediction lookup table and an overdrive circuit. The calculation circuit for lookup tables corrects data in the over-drive lookup table and the prediction lookup table according to the detection result generated from the liquid crystal capacitive sensor. The over-drive circuit performs over-drive control in the liquid crystal display device based on the newly corrected over-drive lookup table and prediction lookup table.

### CROSS REFERENCE TO RELATED APPLICATIONS

This application claims the benefit of Japan application Serial No. 2008-071534 filed Mar. 19, 2008, the subject matter of which is incorporated herein by reference.

### BACKGROUND OF THE INVENTION

1. Field of the Invention

The invention relates to a driving method for a liquid crystal display device and an over-drive correction device using a lookup table to perform an over-drive operation, and more particularly to a data production method of the over-drive correction device, a liquid crystal display device using the over-drive correction device for driving, and an electronic device comprising the liquid crystal display device.

2. Description of the Related Art

In a liquid crystal display device, the response speed of liquid crystal molecules to variations of applied signal voltages is not rapid. Thus, when the liquid crystal display device is switched to display a next image from a current image, the current image is continuously shown on the panel, resulting in a image sticking. An over-drive (OD) technique provides a method to shorten the brightness response time for solving image sticking. The over-drive (OD) technique is used to apply a voltage, which is higher than the voltage corresponding to the gray-level data of the displayed image brightness, for accelerating the response speed of the liquid crystal molecules.

FIGS. 5a and 5b are diagrams illustrating a conventional over-drive technique for a liquid crystal display device, wherein the horizontal axis represents the time (the number of frames) required for variation from the black gray-level to the bright gray-level, and the vertical axis represents the gray-levels displayed by the liquid crystal display device. Herein, one frame is a time interval of 1/60 second for a 60 Hz liquid crystal driving circuit, or about 16.7 ms.

For example, as shown in FIG. 5a, when attempting to achieve the gray-level of the target 1, the signal voltage for the target 1 requires continuous application for 10 frames. Relatively, when a signal voltage for an over-drive target OD1 is applied by the over-drive technique, the gray-level of the target 1 can be achieved in 5 frames, wherein after, the signal voltage for the target 1 is switched for application, so that the response time can be shortened, as shown in FIG. 5b. Similarly, as shown in FIG. 5a, when attempting to achieve the gray-level of the target 2, the signal voltage for the target 2 requires continuous application for 7 frames. Relatively, when a signal voltage for an over-drive target OD2 is applied by the over-drive technique, the gray-level of the target 2 can be achieved in 5 frames, so that the response time can be shortened, as shown in FIG. 5b.

The voltages applied by the over-drive technique are determined according to a lookup table. The lookup table records gray-level data corresponding to the over-drive signal voltages according to the relationship between the predicted current gray-level data (beginning gray-level data) and the image input data (target gray-level data). Data in a conventional lookup table is determined according the data detected during manufacturing of devices thereof.

However, due to different cell gaps of the liquid crystal units during the manufacturing and temperature variations when using liquid crystal display devices, the over-drive operation is not performed according to the data of the lookup table set during the manufacturing process. Thus, over-shoot occurs and the quality of images is degraded. In order to avoid over-shoot, the data of the lookup table is set by a gradualness manner. However, over-drive response speed can not be optimized.

Thus, Japan Publication No 2004-133159 discloses a liquid crystal panel driving device as shown in FIG. 6. The liquid crystal panel driving device uses a frame memory 61 and lookup tables 62 for the over-drive control of a liquid crystal display (LCD) module 64. The lookup tables 62 comprise a plurality of types LUT1, LUT2, etc. corresponding to particular temperatures. According to the detection result generated from a temperature sensor 65 detecting the environment temperature of the LCD module 64, a selection circuit 63 selectively switches the lookup tables 62 with various types.

In the above driving device, lookup tables with a plurality of various types are required. Thus, required memory is increased, raising costs. Moreover, while the lookup tables can correspond to the particular temperatures, they do not correspond to temperatures between the particular temperatures. Thus, the lookup tables are unsuitable for non-particular temperatures.

### BRIEF SUMMARY OF THE INVENTION

Thus, the invention provides a driving method for a liquid crystal display device, an over-drive correction device, a data production method of the over-drive correction device, a liquid crystal display device with the over-drive correction device, and a electronic device with the liquid crystal display device for performing over-drive control under various environmental temperatures and various other factors, without requiring increased memories.

An exemplary embodiment of a driving method for a liquid crystal display device performs an over-drive operation in the liquid crystal display device by using a lookup table. The driving method is characterized by disposing a dummy liquid crystal unit in the liquid crystal display device and correcting data of the lookup table according to gray-level data of the dummy liquid crystal unit. In other words, the data of the lookup table for the over-drive operation is immediately and continuously updated according to the gray-level data of the dummy liquid crystal unit disposed in the liquid crystal display device.

Moreover, according to the exemplary embodiment of the driving method, the gray-level data of the dummy liquid crystal unit and the data of the lookup table is determined according to the detection data generated from a detector of the liquid crystal display device.

According to the exemplary embodiment of the driving method, the detector is a liquid crystal capacitive sensor for detecting a capacitance of the dummy liquid crystal unit. A mapping table is established by the detected capacitance of the dummy liquid crystal unit by the liquid crystal capacitive sensor and gray-level data corresponding to the detected capacitance, and then the data of the lookup table is determined according to the mapping table.

An exemplary embodiment of an over-drive correction device performing an over-drive operation in a liquid crystal display device by using a lookup table and comprising a dummy liquid crystal unit, a detector, and a correction device is provided. The dummy liquid crystal unit is disposed in the liquid crystal display device. The detector detects a state of the dummy liquid crystal unit. The correction device corrects data of the lookup table according the detection result generated from the detector.

In the over-drive correction device, the gray-level data of the lookup table is determined according to the detection data generated from a detector, which is related to the dummy liquid crystal unit of the quid crystal display device.

Moreover, the over-drive correction device further comprises a prediction lookup table for storing predicted over-drive gray-level data, wherein the correction device corrects the data of the prediction lookup table according to the detection result generated from the detector.

In the over-drive correction device, the detector is a liquid crystal capacitive sensor for detecting a capacitance of the dummy liquid crystal unit. A mapping table is established by the detected capacitance of the dummy liquid crystal unit by the liquid crystal capacitive sensor and gray-level data corresponding to the detected capacitance, and then the data of the lookup table is determined according to the mapping table.

Moreover, in the over-drive correction device, the liquid crystal capacitive sensor is formed by a polysilicon transistor circuit and disposed on glass of the liquid crystal display device. Thus, cost is reduced due to the liquid crystal capacitive sensor being formed by a polysilicon transistor circuit.

An exemplary embodiment of a data production method is applied in the above over-drive correction device for producing data for correction. The data production method comprises the step of determining an over-drive time according to a liquid crystal response time required for variation of a gray-level voltage of the dummy liquid crystal unit from the lowest voltage value to the highest voltage value. The mapping table is established according to variation of the gray-level voltage applied in the dummy liquid crystal unit from the highest voltage value to the lowest voltage value. The data of the lookup table is determined according to the mapping table.

According to the data production method, the over-drive time (the number of frames for driving) is determined according to the liquid crystal response time required for variation of the gray-level voltage of the dummy liquid crystal unit from the lowest voltage value to the highest voltage value (the number of frames for response). The mapping table is established according to the variation of the gray-level voltage applied in the dummy liquid crystal unit from the highest voltage value to the lowest voltage value. The data of the lookup table is determined according to the mapping table.

Moreover, the data production method further comprises the step of correcting the data of the prediction lookup table by the correction device.

An exemplary embodiment of a liquid crystal display device comprises the above over-drive correction device for performing an over-drive operation.

An exemplary embodiment of an electronic device comprises the above liquid crystal display device, and the electronic device is one of a cellular phone, a digital camera, a personal digital assistant (PDA), an aviation displayer, an automotive displayer, a digital photo frame, a portable DVD displayer.

According the above embodiments, the lookup table for the over-drive operation is corrected according to the gray-level data of the dummy liquid crystal unit disposed in the liquid crystal display device, so that proper overdrive control can be performed in various operating environments for maximizing the response speed of the liquid crystal display device and shorten the response time. Thus, dynamic image displaying with reduced image sticking effect can be achieved.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1a and 1b are diagrams illustrating an over-drive method according to an embodiment, for a liquid crystal display device;

FIG. 2 shows an exemplary embodiment of an over-drive correction device;

FIG. 3 is a block diagram of an exemplary embodiment of an over-drive driving circuit;

FIG. 4 shows the relationship between variation of the gray-level data and the response time of the dummy liquid crystal unit 22 (the number of frames);

FIGS. 5a and 5b are diagrams illustrating a conventional over-drive technique for a liquid crystal display device; and

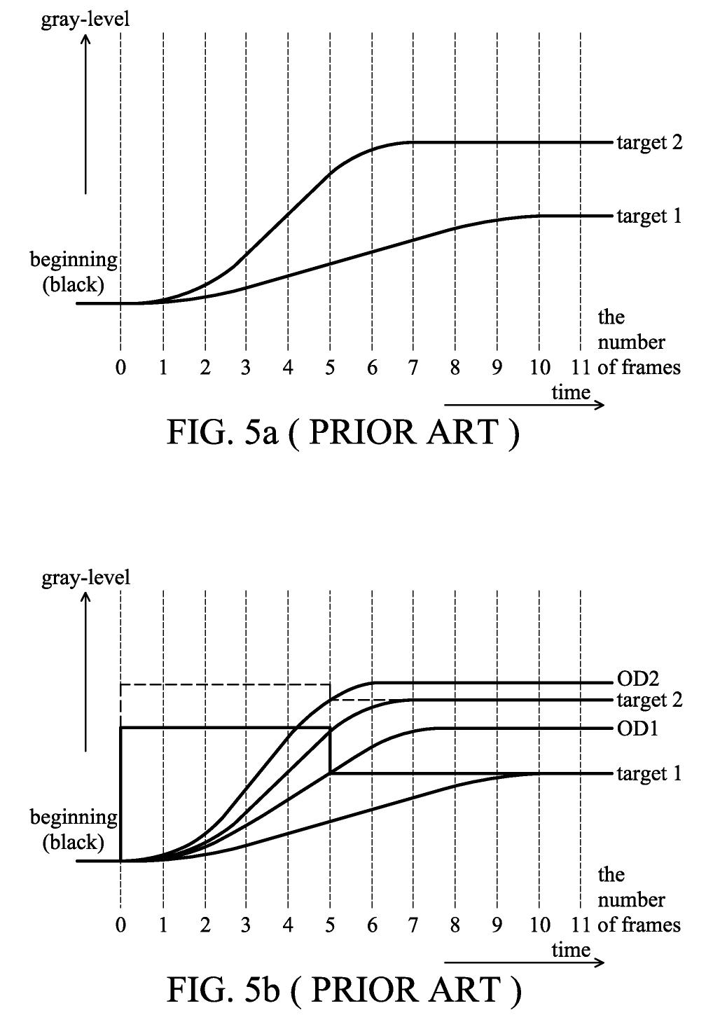

FIG. 6 shows a conventional liquid crystal panel driving device.

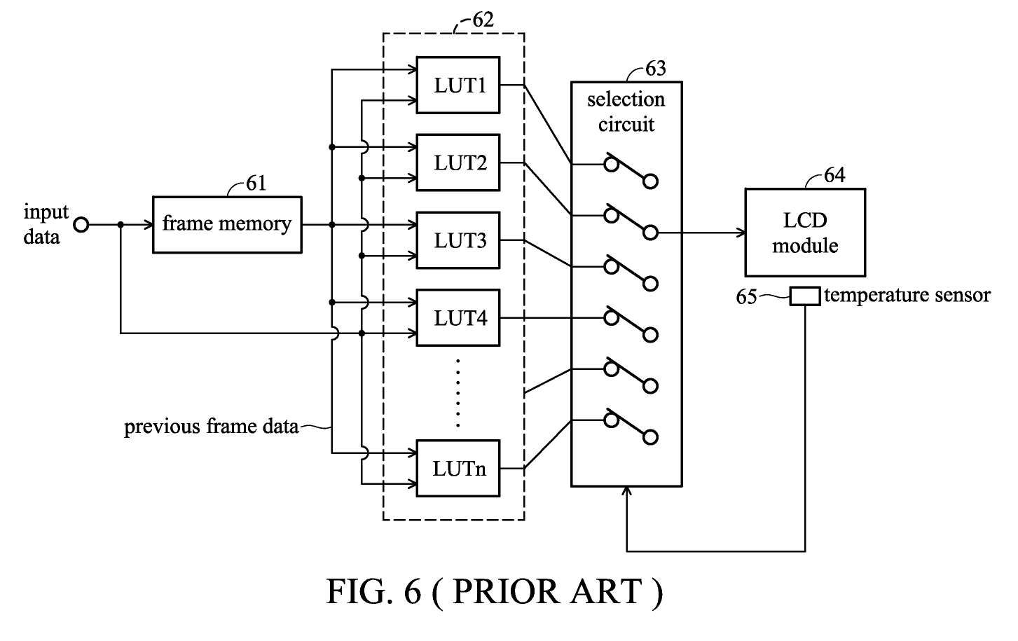

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

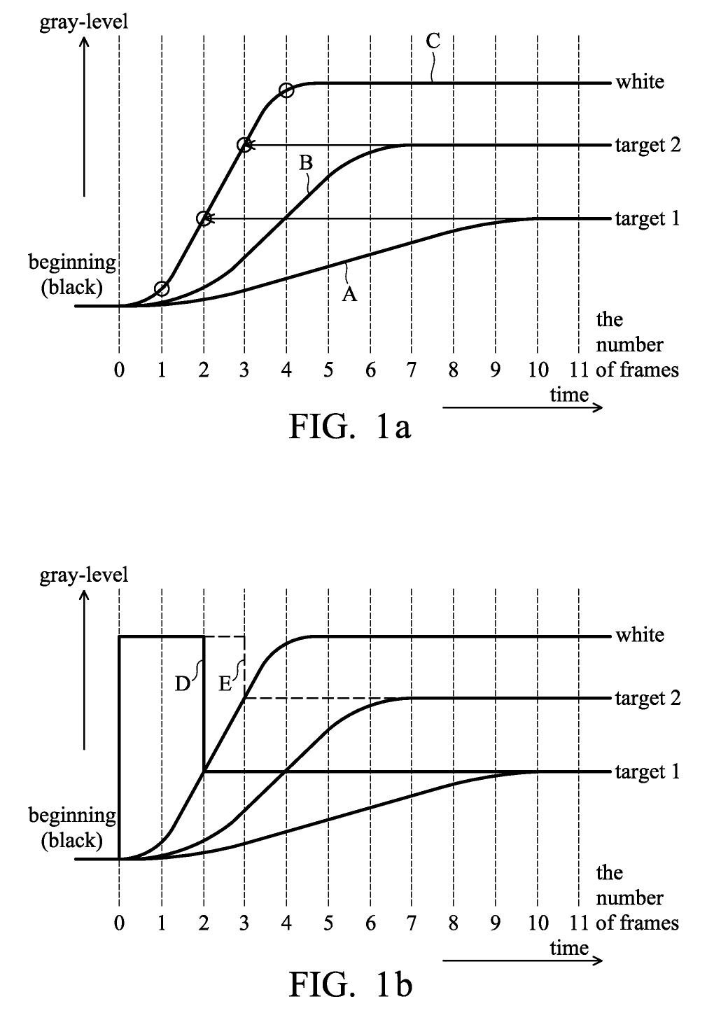

FIGS. 1a and 1b are diagrams illustrating an over-drive method according to an embodiment, for a liquid crystal display device, wherein the horizontal axis represents the time (the number of frames) required for the change from the black gray-level to the bright gray-level, and the vertical axis represents the gray-levels displayed by a liquid crystal display device. In the embodiment, one frame is a time interval of 1/60 second for a 60 Hz liquid crystal driving circuit, or about 16.7 milli-second (ms).

In FIG. 1a, the solid line A represents the gray-level variation when the signal voltage for the target 1 is being continuously applied, the solid line B represents the gray-level variation when the signal voltage for the target 2 is being continuously applied, and the solid line C represents the gray-level variation when the signal voltage for white display is being continuously applied. When the signal voltages for the targets 1 and 2 are continuously applied, 10 frames and 7 frames are required respectively for achieving the gray-level of the target 1 and the gray-level of the target 2. Relatively, when the signal voltage for the white display, the gray-level of the target 1 and the gray-level of the target 2 can be achieved respectively in 2 frames and 3 frames.

In the embodiment, after the predetermined number of frames, the gray-level of the over-drive control is changed according to the feedback prediction gray-level data. That is, as shown in FIG. 1b, in the condition when the gray-level of the target 1 is required, if the signal voltage for the white display is applied, the gray-level of the target 1 can be achieved in 2 frames, wherein thereafter, the signal voltage for the target 1 is switched to be applied. Thus, the response time is shortened to 2 frames from 10 frames, as shown by the solid line D in FIG. 1b. Similarly, in the condition when the gray-level of the target 2 is required, if the signal voltage for the white display is applied, the gray-level of the target 2 can be achieved in 3 frames, wherein thereafter, the signal voltage for the target 2 is switched to be applied. Thus, the response time is shortened to 3 frames from 7 frames, as shown by the dotted line E in FIG. 1b.

In the embodiment, the prediction gray-level data and the over-drive gray-level data is detected and updated by an over-drive correction device which will be described in the following. Thus, even for large temperature ranges occur, over-drive control can still be optimized for shortening response time.

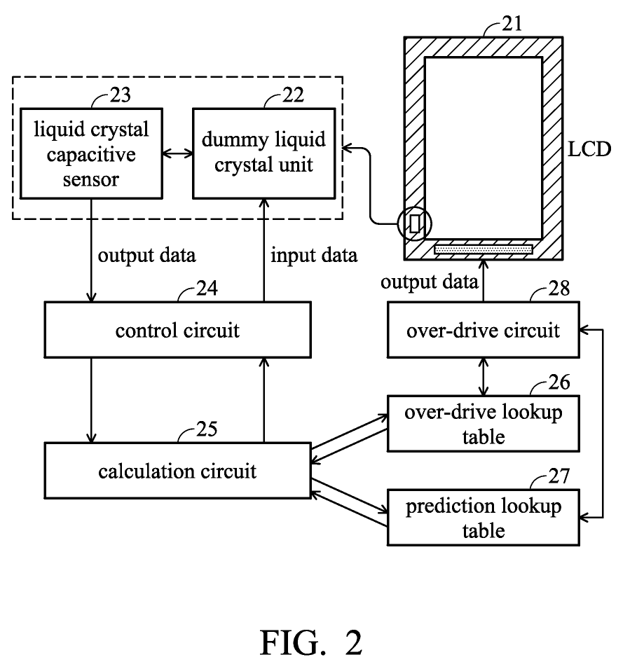

FIG. 2 shows an exemplary embodiment of an over-drive correction device. Referring to FIG. 2, the label “21” represents a liquid crystal display (LCD) device. The over-drive correction device comprises a dummy liquid crystal unit 22 and a liquid crystal capacitive sensor 23 which are embedded in the liquid crystal display device 21, a control circuit 24 for the dummy liquid crystal unit 22/liquid crystal capacitive sensor 23, a calculation circuit 25 for a lookup table (LUT), an over-drive lookup table 26, a prediction lookup table 27, and an over-drive (OD) circuit 28.

The dummy liquid crystal unit 22 is disposed on the outside of the display area of the display crystal display device 21 and applied by the same driving voltage as the liquid crystal display device 21. The liquid crystal capacitive sensor 23 is formed by a polysilicon transistor circuit in a low temperature polysilicon process and disposed on the glass of the liquid crystal display device 21, thereby decreasing cost. The liquid crystal capacitive sensor 23 detects the capacitance (dielectric constant) of the dummy liquid crystal unit 22 and outputs the detection result to the control circuit 24.

The detection result generated from the liquid crystal capacitive sensor 23 (the detected capacitance (dielectric constant) of the dummy liquid crystal unit 22) is input to the calculation circuit 25 through the control circuit 24, and following, the calculation circuit 25 then corrects the data of the over-drive lookup table 26 and the prediction lookup table 27. The over-drive circuit 28 performs the over-drive control of the liquid crystal display device 21 according to the newly corrected new over-drive lookup table 26 and prediction lookup table 27.

Accordingly, the data of the lookup tables 26 and 27 can immediately reflect the capacitance variation of the dummy liquid crystal unit 22 to perform optimized over-drive control. The prediction lookup table 27 is not essential for the over-drive circuit structure. However, to perform optimized over-drive control for large temperature ranges, the prediction lookup table 27 is preferably embedded in the structure.

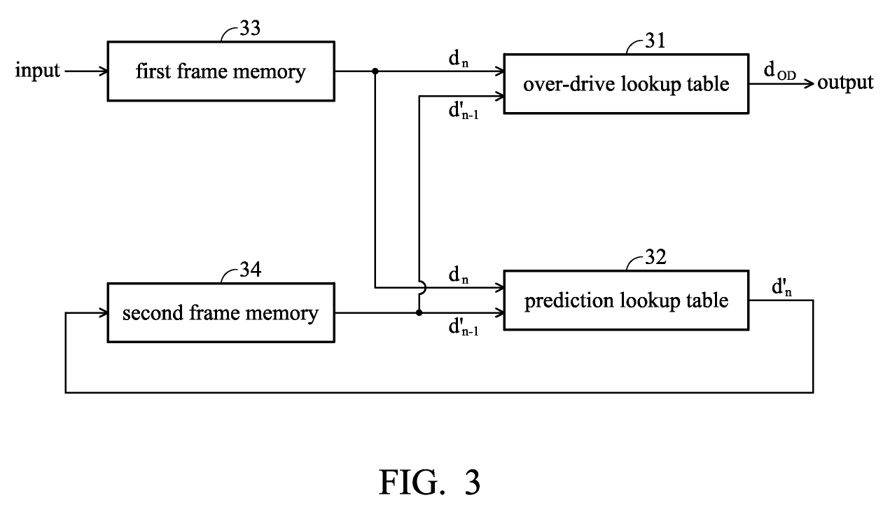

FIG. 3 is a block diagram of an exemplary embodiment of an over-drive driving circuit. An over-drive lookup table 31 compares a target gray-level data dₙ from a first frame memory 33 and a prediction gray-level data d′ₙ₋₁ from a second frame memory 34 and outputs an optimized over-drive signal level d_{OD}, which is used to achieve the target dₙ, to the liquid crystal display device 21.

A prediction lookup table 32 compares the target gray-level data dₙ from the first frame memory 33 and the prediction gray-level data d′ₙ₋₁ from the second frame memory 34 and generates a prediction gray-level data d′ₙ for the next operation timing. Following, the generated prediction gray-level data d′ₙ is fed back to the second frame memory 34. Thus, when the target gray-level is completely achieved at the next timing (that is when the over-drive signal level d_{OD} is not 0 or 255), the prediction lookup table 32 outputs the target gray-level data dₙ to serve as the prediction gray-level data d′ₙ. When the target gray-level is not completely achieved at the next timing (that is when the over-drive signal level d_{OD} is 0 or 255), the prediction lookup table 32 outputs the predicted achieved gray-level data to serve as the prediction gray-level data d′ₙ.

The device for correcting the data of the over-drive lookup table 31 and the prediction lookup table 32 of the over-drive driving circuit in FIG. 3 according to the detection result generated from the liquid crystal capacitive sensor 23 serve as the over-drive correction device in FIG. 2.

In the over-drive correction device, as shown in FIG. 2, during the liquid crystal driving process, the over-drive circuit 28 multiplies the response time from the lowest voltage value (for example the black gray-level) to the highest voltage value (for example the white gray-level) by a predetermined coefficient which is lower than 1, so that the optimized time (the number of frames) for the over-drive can be continuously determined. For example, at a temperature of −30° C., the required time from the black gray-level data to the white gray-level data is equal to 100 frames in a certain liquid crystal mode. It is assumed that the predetermined coefficient k is equal to 0.03 (k=0.03), so that the determined number of frames for the over-drive is 3. Moreover, if the number of frames obtained from multiplying the response time by the e predetermined coefficient less than 1, the determined number of frames for the over-drive is set as 1.

The over-drive correction device of the embodiment comprises a mapping table which contains the capacitance of the dummy liquid crystal unit 22 detected by the liquid crystal capacitive sensor 23 in advance and the gray-level data corresponding to the capacitance. Thus, a corresponding gray-level data can be obtained by looking up the mapping table according to the capacitance data detected by the liquid crystal capacitive sensor 23. The obtained corresponding gray-level data is then input to the calculation circuit 25 through the control circuit 24 for correcting the data of the over-drive lookup table 26 and the prediction lookup table 27.

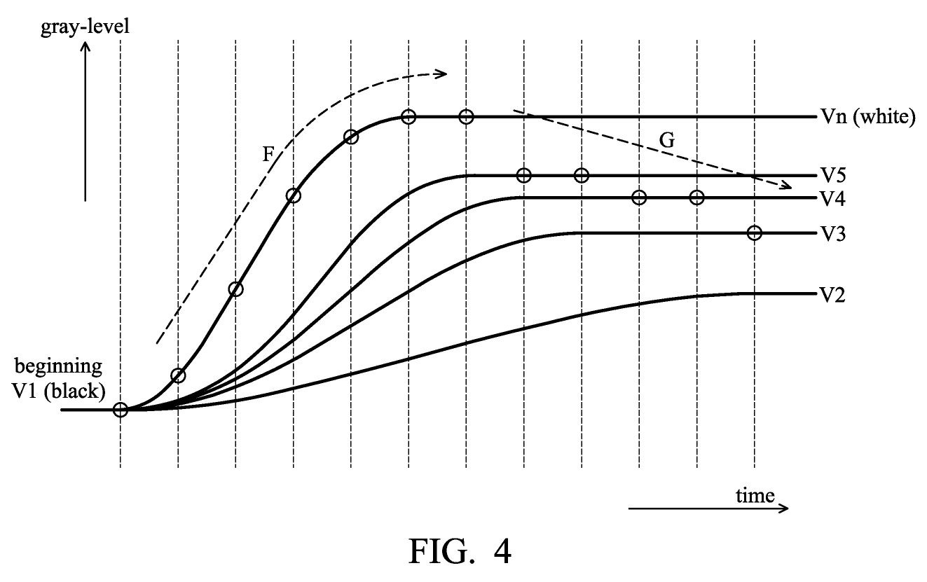

FIG. 4 shows the relationship between variation of the gray-level data and the response time (the number of frames) of the dummy liquid crystal unit 22. According to over-drive correction of the embodiment, in the stage F, as shown in FIG. 4, the liquid crystal response time (the number of frames), which is required for the liquid crystal level of the liquid crystal display device 21 to change from the lowest voltage value to the highest voltage value, and the number of over-drive frames is detected. In the stage G, as shown in FIG. 4, the gray-level voltage applied in the dummy liquid crystal unit 22 is gradually changed from the highest voltage value to the lower voltage value. A mapping table between the capacitance of the dummy liquid crystal unit 22 and the gray-level data corresponding to the capacitance is thus established.

The calculation circuit 25 corrects the data of the over-drive lookup table 26 and the prediction lookup table 27 according to a plurality of detected values, wherein each detected value is the gray-level variation from one gray-level to another gray-level.

Note that a conventional mapping table between capacitance and a corresponding gray-level is established from the lowest voltage to the higher voltage, taking a long time due to the long response time due to the liquid crystal characteristics, for example 17 seconds at −30° C. However, according to the embodiment of the invention, the response time is shorter, and the mapping table can be established in a short time (for example 8.5 seconds at −30° C.). Moreover, in the operation of correcting the data of the over-drive lookup table 26 and the prediction lookup table 27, the detection time can be shortened by optimizing the order of the detection operations.

While a liquid crystal capacitive sensor is given as an example of a detector in the above embodiment, a photo detector can be used. When a photo detector is used, the photo detector is disposed on the outside of the polarizer film of the liquid crystal display device 21. The photo detector detects the brightness of light passing through the liquid crystal unit, and the gray-level data of the over-drive lookup table 26 and the prediction lookup table 27 is determined according to the detection result.

The liquid crystal display device with the over-drive correction device of the embodiment of the invention can be applied in an electronic device, such as a cellular phone, a digital camera, a personal digital assistant (PDA), an aviation displayer, an automotive displayer, a digital photo frame, a portable DVD displayer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving method for a liquid crystal display device, wherein the driving method comprises performing an over-drive operation in the liquid crystal display device by using a lookup table, and the driving method is characterized by:
disposing a dummy liquid crystal unit in the liquid crystal display device; and
correcting data of the lookup table according to gray-level data of the dummy liquid crystal unit.

2. The driving method as claimed in claim 1, wherein the gray-level data of the dummy liquid crystal unit is determined by detection data of a detector embedded in the liquid crystal display device.

3. The driving method as claimed in claim 2, wherein the detector is a liquid crystal capacitive sensor for detecting a capacitance of the dummy liquid crystal unit.

4. The driving method as claimed in claim 3, wherein the data of the lookup table is corrected according to a mapping table, and the mapping table is established by the detected capacitance by the liquid crystal capacitive sensor and gray-level data corresponding to the detected capacitance.

5. The driving method as claimed in claim 1 further comprising continuously determining an over-drive time according to response time from a gray-level of the lowest voltage value to a gray-level of the highest voltage value during a liquid crystal driving process.

6. An over-drive correction device for performing an over-drive operation in a liquid crystal display device by using a lookup table, comprising:
a dummy liquid crystal unit disposed in the liquid crystal display device;
a detector for detecting a state of the dummy liquid crystal unit; and
a correction device for correcting data of the lookup table according the detection result generated from the detector.

7. The over-drive correction device as claimed in claim 6 further comprising a prediction lookup table for storing predicted over-drive gray-level data, wherein the correction device corrects the data of the prediction lookup table according to the detection result generated from the detector.

8. The over-drive correction device as claimed in claim 6, wherein the detector is a liquid crystal capacitive sensor for detecting a capacitance of the dummy liquid crystal unit.

9. The over-drive correction device as claimed in claim 8, wherein liquid crystal capacitive sensor is formed by a polysilicon transistor circuit and disposed on glass of the liquid crystal display device.

10. A data production method applied in an over-drive correction device as claimed in claim 9 for producing data for correction, comprising:
determining an over-drive time according to a liquid crystal response time required for variation of a gray-level voltage of the dummy liquid crystal unit from the lowest voltage value to the highest voltage value;
establishing a mapping table according to the variation of the gray-level voltage of the dummy liquid crystal unit from the lowest voltage value to the highest voltage value, wherein the mapping table comprises a capacitance of the dummy liquid crystal unit and gray-level data corresponding to the capacitance; and
correcting the data of the lookup table according to the mapping table by the correction device.

11. The data production method as claimed in claim 10 further comprising correcting the data of the prediction lookup table by the correction device.

12. A liquid crystal display device comprising:
an over-drive correction device as claimed in claim 6 for performing an over-drive operation.

13. An electronic device comprising:
a liquid crystal display device as claimed in claim 12, wherein the electronic device is one of a cellular phone, a digital camera, a personal digital assistant (PDA), an aviation displayer, an automotive displayer, a digital photo frame, a portable DVD displayer.
